(19) United States
(12) Patent Application Publication
(10) Pub. No.: US 2024/0061648 A1
(43) Pub. Date: Feb. 22, 2024

(54) SCALAR MULTIPLICATION SYSTEM, SCALAR MULTIPLICATION APPARATUS, SCALAR MULTIPLICATION METHOD AND PROGRAM

(71) Applicant: NIPPON TELEGRAPH AND TELEPHONE CORPORATION, Tokyo (JP)

(72) Inventors: Yuto KAWAHARA, Tokyo (JP); Tetsutaro KOBAYASHI, Tokyo (JP)

(21) Appl. No.: 18/260,395

(22) PCT Filed: Jan. 12, 2021
(86) PCT No.: PCT/JP2021/000684

§ 371 Date: Jul. 5, 2023

(51) Int. Cl. G06F 7/523

(52) U.S. Cl. CPC G06F 7/523

(57) ABSTRACT

A scalar multiplication system computes a scalar multiplication for a point on an elliptic curve. The scalar multiplication system includes a computer including a memory and a processor configured to execute computing a pre-computation table T including d points eᵢP having the same Z coordinate in Jacobian coordinates using elliptic curve point addition or elliptic curve point doubling according to a Co—Z method for a point P on the elliptic curve and d integers eᵢ(i∈[1, d]); converting a scalar value k into a scalar value k′ expressed as k′=k₀′2⁰+k₁′2¹+ . . . +kₙ₋₁′2ⁿ⁻¹ (kᵢ′∈{0, e₁, . . . , ±e_{d}}); and using the pre-computation table T and the scalar value k′ to compute a scalar multiplication k′P using the elliptic curve point addition according to the Co—Z method.

### TECHNICAL FIELD

The present invention relates to a scalar multiplication system, a scalar multiplication device, a scalar multiplication method, and a program.

### BACKGROUND ART

In an encryption scheme using elliptic curve cryptography or pairing-based cryptography, the computational cost of scalar multiplication/multi-scalar multiplication on an elliptic curve is dominant. For this reason, various methods for efficiently executing scalar multiplication/multi-scalar multiplication have been proposed.

The methods for efficiently executing scalar multiplication/multi-scalar multiplication can be roughly divided into a method using a pre-computation table and a method not using a pre-computation table. A method using a pre-computation table is called scalar multiplication/multi-scalar multiplication with precomputation (or scalar multiplication/multi-scalar multiplication with online precomputation), and a w-NAF method, a window method, a sliding window method, and the like are known. In addition, a method for executing pre-computation processing in scalar multiplication with precomputation using the Co—Z method is also known (Non-Patent Literature 1). Note that the Co—Z method is a method for efficiently computing elliptic curve point addition in Jacobian coordinates.

### CITATION LIST

### Non-Patent Literature

Non-Patent Literature 1: Yoshitaka Nagai, Masaaki Shirase, Tetsuya Izu, Yumi Sakami, “Acceleration of scalar multiplication using Co—Z method,” SCIS 2014, 2014.

### SUMMARY OF INVENTION

### Technical Problem

However, in the conventional scalar multiplication/multi-scalar multiplication with precomputation using the Co—Z method, for example, it is necessary to perform elliptic curve point addition in Jacobian coordinates without using the Co—Z method in part of the processing, or it is necessary to convert the Jacobian coordinates to the affine coordinates. For this reason, some of the elliptic curve point additions become inefficient, or an extra computational cost is incurred for conversion of the coordinates.

An embodiment of the present invention has been made in view of the above points, and an object thereof is to efficiently execute scalar multiplication/multi-scalar multiplication with precomputation.

### Solution to Problem

In order to achieve the above object, a scalar multiplication device according to an embodiment is a scalar multiplication system that computes a scalar multiplication for a point on an elliptic curve, the scalar multiplication system including: a pre-computation unit that computes a pre-computation table T including d points eᵢP having the same Z coordinate in Jacobian coordinates using elliptic curve point addition or elliptic curve point doubling according to a Co—Z method for a point P on the elliptic curve and d integers eᵢ(i∈[1, d]); a conversion unit that converts a scalar value k into a scalar value k′ expressed as k′=k₀′2⁰+k₁′2¹+ . . . +kₙ₋₁′2ⁿ⁻¹ (kᵢ′∈{0, ±eᵢ, . . . , ±e_{d}}); and an evaluation unit that uses the pre-computation table T and the scalar value k′ to compute a scalar multiplication k′P using the elliptic curve point addition according to the Co—Z method.

### Advantageous Effects of Invention

The scalar multiplication/multi-scalar multiplication with precomputation can be executed efficiently.

### BRIEF DESCRIPTION OF DRAWINGS

FIG. 1 is a diagram illustrating an example of an algorithm of multi-scalar multiplication using a conventional binary method.

FIG. 2 is a diagram illustrating an example of an algorithm of scalar multiplication with precomputation according to a conventional w-NAF method.

FIG. 3 is a diagram illustrating an example of an algorithm of pre-computation processing according to the present embodiment.

FIG. 4 is a diagram illustrating an example of an algorithm of evaluation processing according to the present embodiment.

FIG. 5 is a diagram illustrating an example of a hardware configuration of a scalar multiplication device according to the present embodiment.

FIG. 6 is a diagram illustrating an example of a functional configuration of the scalar multiplication device according to the present embodiment.

FIG. 7 is a diagram illustrating an example of a flowchart of scalar multiplication with precomputation according to the present embodiment.

FIG. 8 is a diagram illustrating an algorithm of pre-computation processing of scalar multiplication with precomputation according to a w-NAF method in an example.

FIG. 9 is a diagram illustrating an algorithm of evaluation processing of scalar multiplication with precomputation according to a w-NAF method in an example.

### DESCRIPTION OF EMBODIMENTS

Hereinafter, one embodiment of the present invention will be described. In the present embodiment, a scalar multiplication device 10 capable of efficiently executing scalar multiplication/multi-scalar multiplication with precomputation using the Co—Z method will be described. Note that the scalar multiplication device 10 according to the present embodiment can be implemented by various devices such as a general-purpose server, a personal computer (PC), a smartphone, a tablet terminal, an embedded device, and a wearable device, for example.

<Preparation>

First, several terms, concepts, and the like will be prepared.

For a prime number p and a positive integer c, a finite field is F_{q} where q=p^{c}. Note that, although F would be written in an outline letter (blackboard bold) to be accurate, it is written as “F” in the text of the specification.

For an elliptic curve E defined on the finite field F_{q}, a set of F_{q}-rational points on the elliptic curve is defined as follows:

E(F_{q})={(x,y)∈E|x,y∈F_{q}}∪O

where O is an infinite point.

At this time, it is known that E(F_{q}) forms an additive group. That is, in E(F_{q}), the elliptic curve point addition R=P+Q (where P≠±Q) and the elliptic curve point doubling R=2P can be computed for any P, Q∈E(F_{q}). Furthermore, the infinite point O is the zero element of the additive group, and P+O=P is satisfied for any point P∈E(F_{q}). Hereinafter, the elliptic curve point addition and the elliptic curve point doubling are also referred to as point addition and point doubling, respectively.

<<Coordinates>>

Affine coordinates are coordinates in which a point P∈E(F_{q}) on an elliptic curve is expressed as P=(x, y) (x, y∈F_{q}). On the other hand, Jacobian coordinates are coordinates in which a point P∈E(F_{q}) on an elliptic curve is expressed as P=(X, Y, Z) (X, Y, Z∈F_{q}). The point P=(X, Y, Z) (where Z≠0) in the Jacobian coordinates can be converted into a point in the affine coordinates by computation of (X/Z², Y/Z³)=(x, y). Hereinafter, the X coordinate, the Y coordinate, and the Z coordinate of an arbitrary point P∈E(F_{q}) on the elliptic curve in the Jacobian coordinates are expressed as P_{X}, P_{Y}, and P_{Z}, respectively.

<<Co-Z Method>>

Let the expressions of points P, Q∈E(F_{Q}) on the elliptic curve in the Jacobian coordinates be P=(P_{X}, P_{Y}, P_{Z}), Q=(Q_{X}, Q_{Y}, Q_{Z}). At this time, the Co—Z method is a method capable of efficiently computing the elliptic curve point addition P+Q if P_{Z}=Q_{Z}.

By using the Co—Z method, the following elliptic curve point addition can be efficiently computed in the Jacobian coordinates.

(R,P′,t)←P+Q

where the point R is an addition result of P+Q, the point P′ is a point equivalent to P and satisfying P′z=R_{Z} (that is, the Z coordinate of P′ is the same as that of R), and t is an auxiliary output satisfying R_{Z}=tP_{Z}.

Similarly, by using the Co—Z method, the following elliptic curve point doubling can be efficiently computed in the Jacobian coordinates.

(R,P′,t)←2P

where the point R is a result of 2P, the point P′ is a point equivalent to P and satisfying P′_{Z}=R_{Z}, and t is an auxiliary output satisfying R_{Z}=tP_{Z}.

Note that for details of the Co—Z method, refer to, for example, Non-Patent Literature 1, Reference Literature 1 “N. Meloni, “New Point Addition Formulae for ECC Applications,” WAIFI 2007, LNCS 4547, pp. 189-201, 2007”, and the like.

<<Scalar Multiplication/Multi-Scalar Multiplication>>

Scalar multiplication on the elliptic curve is a computation that obtains, for a point P∈E(F_{q}) on the elliptic curve and an integer k of 0 or greater, kP expressed as follow:

$$\\ \begin{matrix}kP = {\underbrace{P + P + … + P}}_{k pieces} & [ Math . 1 ]\end{matrix}$$

Multi-scalar multiplication is an extension of the scalar multiplication, and is a computation that obtains, for m points P₀, . . . , and Pₘ₋₁ on the elliptic curve and m integers k₀, . . . , kₘ₋₁ of 0 or greater, the following.

$$\\ \begin{matrix}{\sum }_{i = 0}^{m - 1} {k}_{i} {P}_{i} = {k}_{0} {P}_{0} + … + {k}_{m - 1} {P}_{m - 1} & [ Math . 2 ]\end{matrix}$$

Each scalar value kᵢ is an n-bit binary number expressed as follow:

$$\\ \begin{matrix}{k}_{i} = ( {k}_{i , n - 1} , … , {k}_{i , 0} ) = {\sum }_{j = 0}^{n - 1} {k}_{i , j} {2}^{j} ( {k}_{i , j} ∈ \{ 0 , 1 \} ) & [ Math . 3 ]\end{matrix}$$

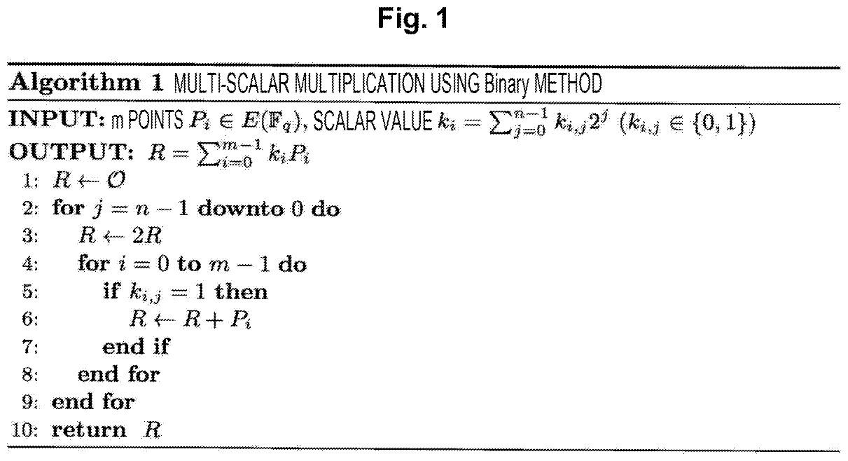

At this time, a binary method is known as an algorithm of the most basic multi-scalar multiplication. This algorithm is a method that does not use a pre-computation table. FIG. 1 illustrates an example of an algorithm of multi-scalar multiplication using the binary method. As illustrated in FIG. 1, the algorithm of the multi-scalar multiplication using the binary method uses m points P₀, . . . , Pₘ₋₁∈E(F_{q}) and m scalar values k₀, . . . , kₘ₋₁ as inputs, and outputs a result R of the multi-scalar multiplication. The algorithm is initialized with R←O (line 1), and then repeats the procedures of lines 3 to 8 while decreasing j by 1 from j=n−1 to j=0 (line 2), and finally outputs R (line 10). In the procedures of lines 3 to 8, R←2R is set at first (line 3), and then the procedures of lines 5 to 7 are repeated while increasing i by 1 from i=0 to i=m−1 (line 4). In the procedures of lines 5 to 7, if k_{i,j}=1 (line 5), then R is updated by R R+Pᵢ (line 6).

<<Scalar Multiplication/Multi-Scalar Multiplication with Precomputation>>

Hereinafter, in order to simplify the description, scalar multiplication with precomputation will be described. As described above, since multi-scalar multiplication is an extension of scalar multiplication, the following description can be easily extended to multi-scalar multiplication.

In the scalar multiplication with precomputation, a result kP of the scalar multiplication is computed by the following three processes for a point P∈E(F_{q}) and a scalar value k.

Pre-computation processing: For a point P∈E(F_{q}) and d integers eᵢ, . . . , e_{d}, points eᵢP (i∈[1, d]) are computed, to set a pre-computation table T={eᵢP, . . . , e_{d}P}.

Scalar value conversion processing: A scalar value k is converted into a scalar value k′ expressed as k₀′2⁰+k₁′2¹+ . . . +kₙ₋₁′2ⁿ⁻¹. Here, kᵢ′∈{0, ±e₁, . . . , ±e_{d}}.

That is, in the scalar value conversion processing, in a case where 2 is a base, a mantissa corresponding to 2ⁱ (where i∈[0, n−1]) is kᵢ′, and k is expressed as (kₙ₋₁′, . . . , k₀′) in a numerical notation, each digit is converted into a value k′ of 0 or ±eᵢ (i∈[1, d]).

Evaluation processing: k′P is computed by elliptic curve point addition and elliptic curve point doubling using the pre-computation table T and the scalar value k′.

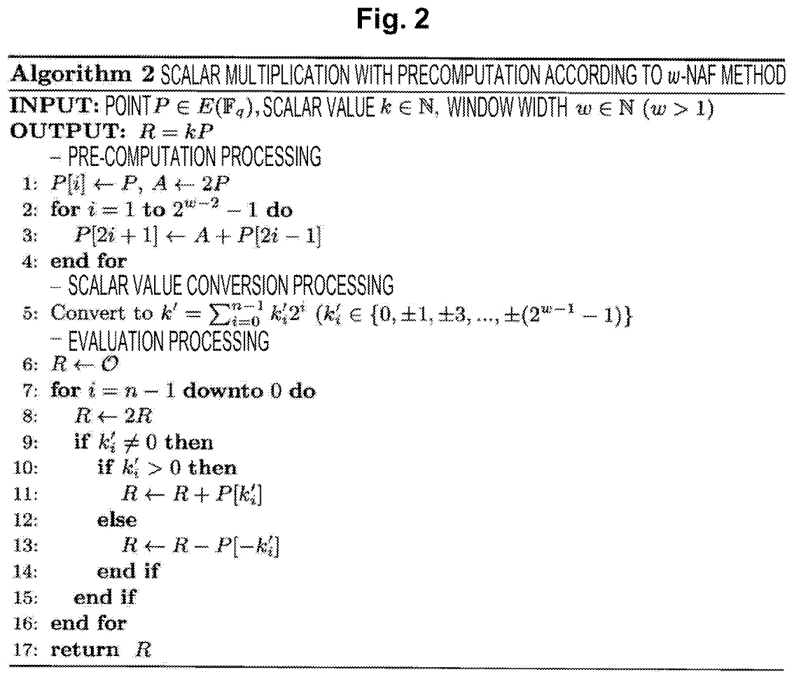

A w-NAF method is known as one of methods for executing scalar multiplication with precomputation at a high speed. FIG. 2 illustrates an example of an algorithm of scalar multiplication with precomputation according to the w-NAF method. As illustrated in FIG. 2, the algorithm of the scalar multiplication with precomputation according to the w-NAF method uses a point P∈E(F_{q}), a scalar value k∈N(where N is a set of all natural numbers), and a window width w∈N(where w>1) as inputs and outputs a result R=kP of the scalar multiplication. After executing the pre-computation processing (lines 1 to 4), the scalar value conversion processing (line 5), and the evaluation processing (lines 6 to 16), R is finally output (line 17).

In the pre-computation processing, P[i]←P and A←2P are initialized for i=1 (line 1), and then P[2i+1]←A+P[2i−1] is set while increasing i by 1 from i=1 to i=2^{w-2}−1 (lines 2 to 4). Accordingly, the pre-computation table T={P[1], P[3], . . . , P[2^{w-1}−1]}={P, 3P, . . . , (2^{w-1}−1)P} is obtained.

In the scalar value conversion processing, the scalar value k is converted into k′=k₀′2⁰+k₁′2¹+ . . . +kₙ₋₁′2ⁿ⁻¹ (where kᵢ′∈{0, ±1, ±3, . . . , ±(2^{w-1}−1)}) (line 5).

In the evaluation processing, after initialization of R←O (line 6), the procedures of lines 8 to 15 are repeated while decreasing i by 1 from i=n−1 to i=0 (line 7). In the procedures of lines 8 to 15, after setting R←2R (line 8), if kᵢ′≠0 and kᵢ′>0, then R is updated by R←R+P[kᵢ′] (line 11), if kᵢ′≠0 and kᵢ′≤0, then R is updated by R←R−P[−kᵢ′] (line 13), and in other cases, nothing is performed.

<Scalar Multiplication/Multi-Scalar Multiplication with Precomputation According to Present Embodiment>

Next, scalar multiplication/multi-scalar multiplication with precomputation according to the present embodiment will be described. Hereinafter, in order to simplify the description, the scalar multiplication with precomputation according to the present embodiment will be mainly described. As described above, since multi-scalar multiplication is an extension of scalar multiplication, the following description can be easily extended to multi-scalar multiplication.

In the scalar multiplication according to the present embodiment, the elliptic curve point addition and the elliptic curve point doubling according to the Co—Z method are used to create the pre-computation table T in which the Z coordinates of all the points e₁P, . . . , e_{d}P computed in the pre-computation processing have the same value. This makes it possible to efficiently compute elliptic curve point addition according to the Co—Z method even in the evaluation processing. The scalar value conversion processing is similar to the conventional scalar multiplication with precomputation (for example, a conventional w-NAF method, sliding window method, or the like).

<<Pre-Computation Processing>>

A point P∈E(F_{q}) and d points computed by the pre-computation processing is set as {P(=e₁P), e₂P, . . . , e_{d}P}. Further, it is assumed that eᵢP can be computed as follows with ‘a’ being a natural number.

eᵢP←eᵢ₋₁P+aP or eᵢP←2ₑ₋₁P

Each eᵢP may be a negative point as appropriate.

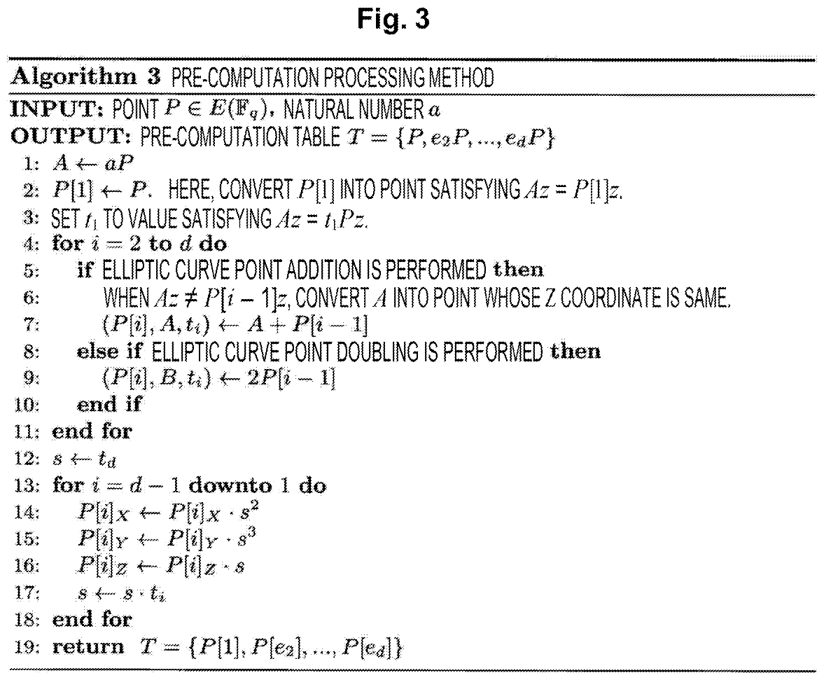

At this time, FIG. 3 illustrates an example of an algorithm of the pre-computation processing for creating the pre-computation table T={P, e₂P, . . . , e_{d}P} in which the Z coordinates of all points are the same. As illustrated in FIG. 3, the pre-computation processing of the scalar multiplication with precomputation according to the present embodiment uses a point P∈E(F_{q}) and a natural number a as inputs and outputs a pre-computation table T={P, e₂P, . . . , e_{d}P}. In FIG. 3, P[eᵢ] (where i∈[1, d]) is written as P[i] in order to simplify the notation.

In the pre-computation processing illustrated in FIG. 3, first, A←aP, P[1]←P, and t₁ are set to a value satisfying A_{Z}=t₁P_{Z} in the procedures of lines 1 to 3. However, in the procedure of line 2, conversion is performed to obtain a point (that is, P[1] is a point whose Z coordinate is the same as the Z coordinate of A) at which A_{Z}=P[1]_{Z} holds.

Next, the procedures of lines 5 to 10 are repeated while increasing i by 1 from i=2 to i=d (line 4). In the procedures of lines 5 to 10, if elliptic curve point addition is performed, then, when A_{Z}≠P[i−1]_{Z}, A is converted into a point whose Z coordinate is the same as P[i−1] (line 6), and (P[i], A, tᵢ)←A+P[i−1] is set (line 7). On the other hand, if elliptic curve point doubling is performed, then (P[i], B, tᵢ)←2P[i−1] is set (line 9). Note that elliptic curve point addition according to the Co—Z method is used in line 7, and elliptic curve point doubling according to the Co—Z method is used in line 9.

Subsequently, after setting s←t_{d} (line 12), the procedures of lines 14 to 17 are repeated while decreasing i by 1 from i=d−1 to i=1 (line 13). In the procedures of lines 14 to 17, P[i]_{X}←P[i]_{X}·s², P[i]_{Y}, P[i]_{Y}·s³, P[i]_{Z}←P[i]_{Z}·s, and s←s·tᵢ are performed. Accordingly, the Z coordinates of each P[i]=(P[i]_{X}, P[i]_{Y}, P[i]_{Z}) are the same.

Finally, the pre-computation table T={P[1], P[e₂], . . . , P[e_{d}])=(P, e₂P, . . . , e_{d}P} is output (line 19).

In addition, in the elliptic curve point addition according to the Co—Z method, tᵢ² and tᵢ³ can be computed without a computational cost instead of tᵢ. Therefore, the efficiency can be improved by directly computing s² and s³ without sequentially computing s² and s³ in lines 14 and 15 of the pre-computation processing illustrated in FIG. 3.

In addition, in a case where the pre-computation processing illustrated in FIG. 3 is applied to the multi-scalar multiplication k₀P₀+ . . . +kₘ₋₁ Pₘ₋₁, the procedures of lines 1 to 11 in FIG. 3 are executed for each Pᵢ, and then the procedures of lines 12 to 19 in FIG. 3 are executed for all Pᵢ. At this point, before the procedures of lines 1 to 11 in FIG. 3 are executed on Pᵢ of i≥1, Pᵢ is converted such that P_{iZ}=Pᵢ₋₁[e_{d}]_{Z} (that is, the Z coordinate of Pᵢ is the same as the Z coordinate of Pᵢ₋₁[e_{d}]) is satisfied with respect to the Z coordinate of Pᵢ₋₁ [e_{d}].

<<Scalar Value Conversion Processing>>

As described above, the scalar value conversion processing of scalar multiplication with precomputation according to the present embodiment is similar to the conventional scalar value conversion processing of scalar multiplication with precomputation. Note that, in the case of application to the multi-scalar multiplication k₀P₀+ . . . +kₘ₋₁ Pₘ₋₁, it is sufficient to perform the scalar value conversion processing on each kᵢ(i∈[0, m−1]).

<<Evaluation Processing>>

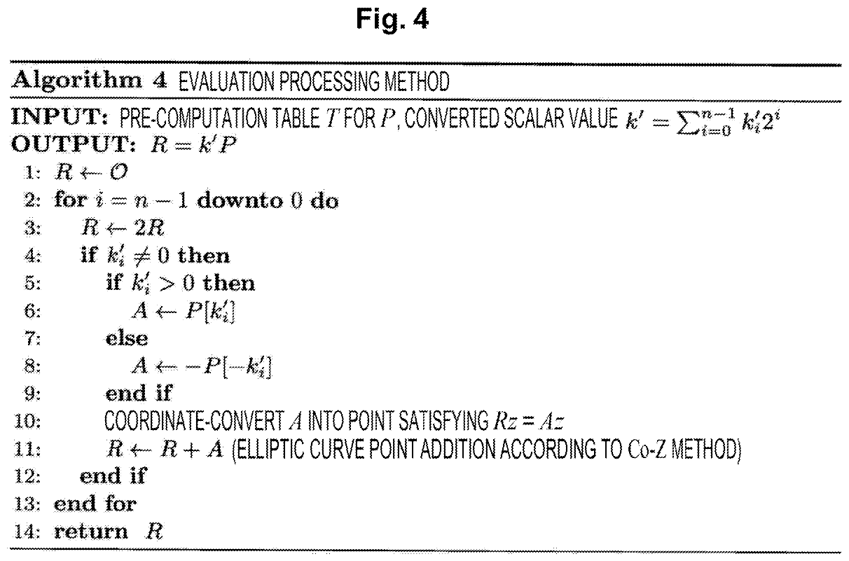

Assume that the pre-computation table is T, and the scalar value after scalar value conversion is k′=k₀′2⁰+k₁′2¹+ . . . +kₙ₋₁′2ⁿ⁻¹ (where kᵢ′∈{0, ±e₁, . . . , ±e_{d}}). At this time, FIG. 4 illustrates an algorithm of the evaluation processing of the scalar multiplication with precomputation according to the present embodiment. As illustrated in FIG. 4, the evaluation processing of the scalar multiplication with precomputation according to the present embodiment uses the pre-computation table T and the scalar value k′ after the scalar value conversion as inputs and outputs a result R=k′P of the scalar multiplication.

In the evaluation processing illustrated in FIG. 4, after initialization of R←0 (line 1), the procedures of lines 3 to 12 are repeated while decreasing i by 1 from i=n−1 to i=0 (line 2), and R is finally output (line 14). In the procedures of lines 3 to 12, after R←2R (line 3), if kᵢ′≠0 and kᵢ′>0, then A←P[kᵢ′] is set (line 6), and if kᵢ′≠0 and kᵢ′≥0, then A←−P[−kᵢ′] is set (line 8), A is converted (that is, conversion into a point at which R and Z coordinates are the same) into a point satisfying R_{Z}=A_{Z} (line 10), and then R is updated by R←R+A (line 11). On the other hand, if kᵢ′=0, nothing is performed. Note that elliptic curve point addition according to the Co—Z method is used in line 11, thereby achieving improved efficiency of scalar multiplication.

Note that the evaluation processing illustrated in FIG. 4 can be directly applied to the multi-scalar multiplication.

<Hardware Configuration of Scalar Multiplication Device 10>

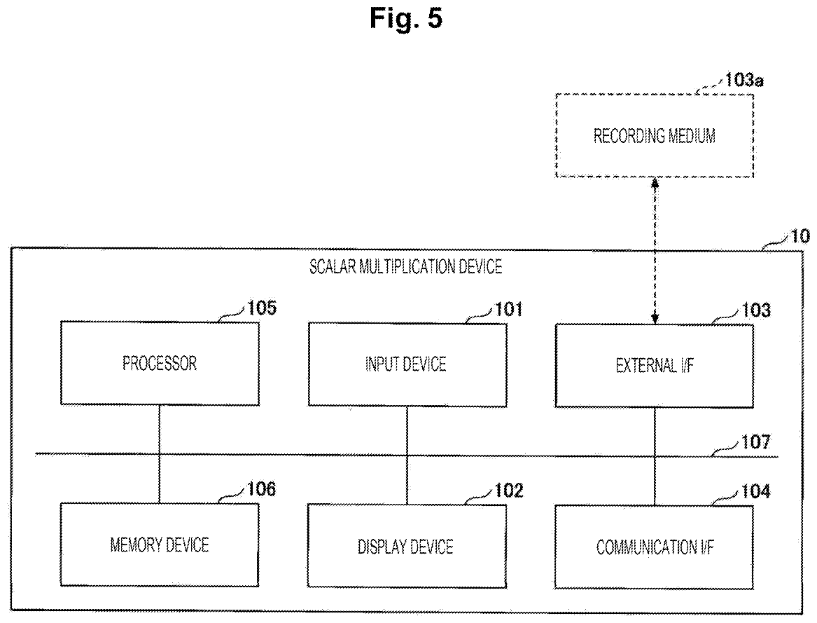

Next, a hardware configuration of the scalar multiplication device 10 according to the present embodiment will be described with reference to FIG. 5. FIG. 5 is a diagram illustrating an example of a hardware configuration of the scalar multiplication device 10 according to the present embodiment.

As illustrated in FIG. 5, the scalar multiplication device 10 according to the present embodiment includes an input device 101, a display device 102, an external interface I/F 103, a communication I/F 104, a processor 105, and a memory device 106. These hardware constituents are communicatively connected to each other via a bus 107.

The input device 101 is, for example, a keyboard, a mouse, a touch panel, various buttons, or the like. The display device 102 is, for example, a display, a display panel, or the like. Note that the scalar multiplication device 10 may not include at least one of the input device 101 and the display device 102.

The external I/F 103 is an interface with an external device such as a recording medium 103a. Examples of the recording medium 103a include a compact disc (CD), a digital versatile disk (DVD), a secure digital memory card (SD memory card), a Universal Serial Bus (USB) memory card, and the like.

The communication I/F 104 is an interface for connecting the scalar multiplication device 10 to a communication network. The processor 105 is any of various arithmetic/logic devices such as a central processing unit (CPU) and a micro processing unit (MPU). The memory device 106 is any of various storage devices such as a hard disk drive (HDD), a solid state drive (SSD), a random access memory (RAM), a read only memory (ROM), and a flash memory.

Since the scalar multiplication device 10 according to the present embodiment has the hardware configuration illustrated in FIG. 5, it is possible to implement scalar multiplication with precomputation, which will be described later. However, the hardware configuration illustrated in FIG. 5 is an example, and the hardware configuration of the scalar multiplication device 10 is not limited thereto.

<Functional Configuration of Scalar Multiplication Device 10>

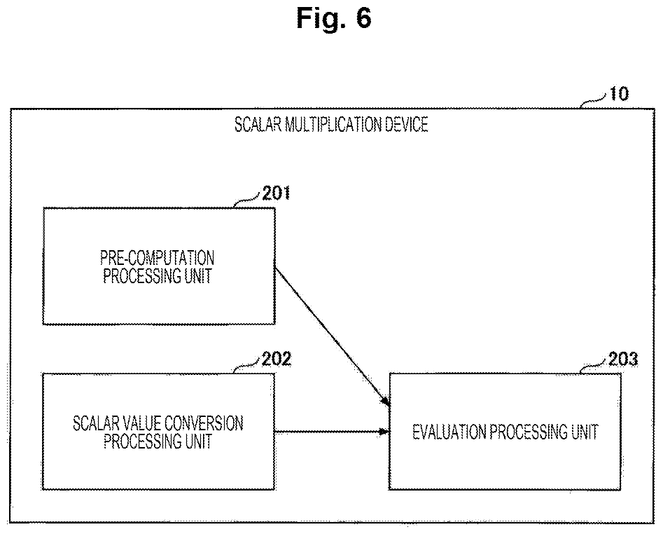

Next, a functional configuration of the scalar multiplication device 10 according to the present embodiment will be described with reference to FIG. 6. FIG. 6 is a diagram illustrating an example of a functional configuration of the scalar multiplication device 10 according to the present embodiment.

As illustrated in FIG. 6, the scalar multiplication device 10 according to the present embodiment includes a pre-computation processing unit 201, a scalar value conversion processing unit 202, and an evaluation processing unit 203. Each of these units is implemented by processing that one or more programs installed in the scalar multiplication device 10 cause the processor 105 to execute.

The pre-computation processing unit 201 executes pre-computation processing by the algorithm illustrated in FIG. 3. Note that the pre-computation table T created by the pre-computation processing is stored in the memory device 106.

The scalar value conversion processing unit 202 converts the scalar value k into a scalar value k′ by conventional scalar value conversion processing of scalar multiplication with precomputation.

The evaluation processing unit 203 executes evaluation processing by the algorithm illustrated in FIG. 4. Accordingly, the result of scalar multiplication (or the result of multi-scalar multiplication when the algorithm illustrated in FIG. 3 is applied to the multi-scalar multiplication) is obtained.

<Flow of Scalar Multiplication with Precomputation>

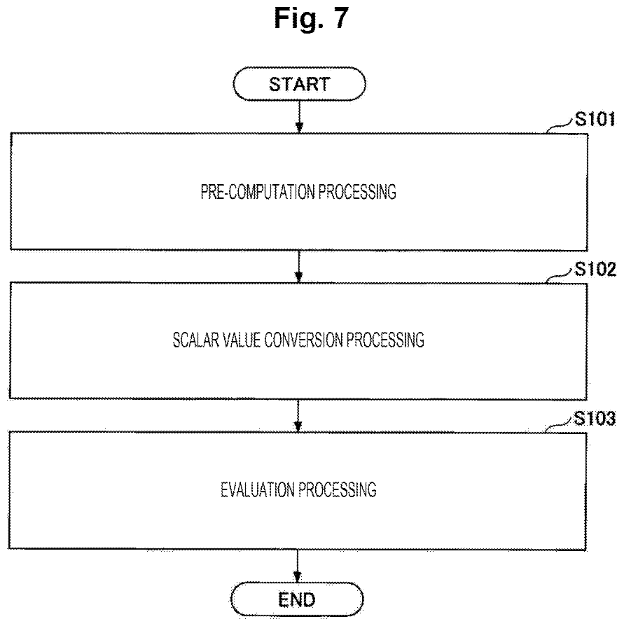

Next, a flow of scalar multiplication with precomputation according to the present embodiment will be described with reference to FIG. 7. FIG. 7 is a diagram illustrating an example of a flowchart of scalar multiplication with precomputation according to the present embodiment.

First, the pre-computation processing unit 201 executes pre-computation processing by the algorithm illustrated in FIG. 3 (step S101). Next, the scalar value conversion processing unit 202 converts the scalar value k into a scalar value k′ by conventional scalar value conversion processing of scalar multiplication with precomputation (step S102). Then, the evaluation processing unit 203 executes evaluation processing by the algorithm illustrated in FIG. 4 (step S103). However, steps S101 and S102 are in no particular order, and step S101 may be executed after step S102 is executed.

### EXAMPLES

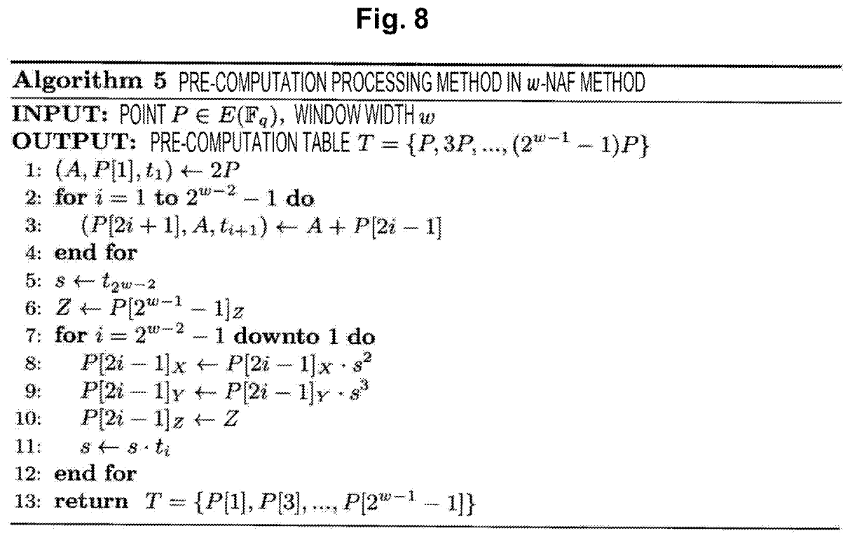

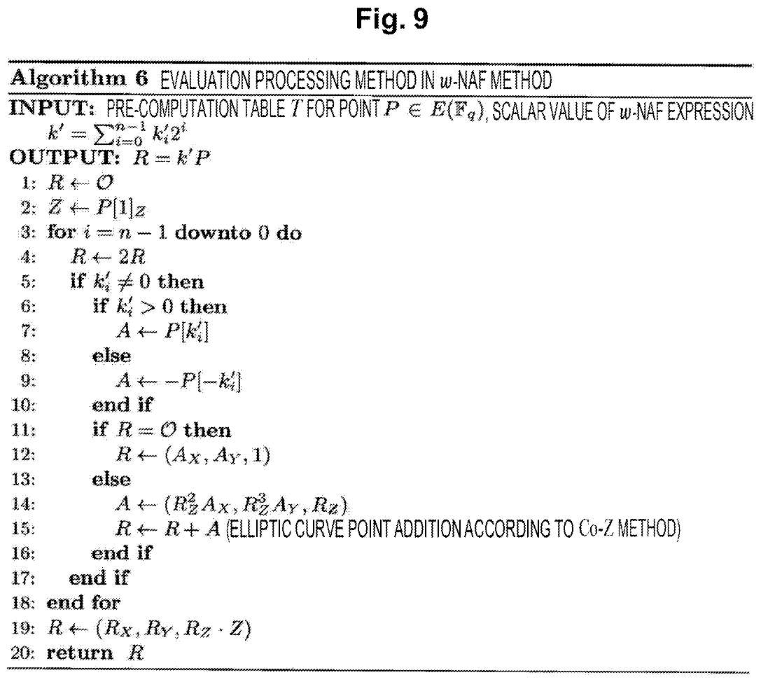

Next, as an example of scalar multiplication with precomputation according to the present embodiment, a case where the present embodiment is applied to the w-NAF method will be described. FIGS. 8 and 9 illustrate algorithms of the pre-computation processing and the evaluation processing in a case where a point P∈E(F_{q}) on the elliptic curve, the scalar value k, and the window width w are given to the scalar multiplication device 10. Note that the pre-computation processing is executed by the pre-computation processing unit 201, and the evaluation processing is executed by the evaluation processing unit 203. In addition, since the scalar value conversion processing is similar to the conventional w-NAF method, description thereof is omitted, but the scalar value conversion processing is executed by the scalar value conversion processing unit 202.

<<Pre-Computation Processing>>

In the pre-computation processing illustrated in FIG. 8, first, (A, P[1], tᵢ)←2P is set (line 1), and (P[2i+1], A, tᵢ₊₁)←A+P[2i−1] is set while increasing i by 1 from i=1 to i=2^{w-2}−1 (line 3). Note that the procedure of line 1 is elliptic curve point doubling according to the Co—Z method, and the procedure of line 3 is elliptic curve point addition according to the Co—Z method.

Next, after setting

s←t₂w−2 [Math. 4]

and Z←P[2^{w-1}−1]_{Z} (lines 5 and 6), the procedures of lines 8 to 11 are repeated while decreasing i by 1 from i=2^{w-2}−1 to i=1 (line 7). In the procedures of lines 8 to 11, P[2i−1]_{X}←P[2i−1]_{X}·s², P[2i−1]_{Y}←P[2i−1]_{Y}·s³, and P[2i−1]_{Z}←Z and s←s·tᵢ are performed.

Finally, the pre-computation table T={P[1], P[3], . . . , P[2^{w-1}−1]}={P, 3P, . . . , (2^{w-1}−1) P} is output (line 13).

<<Evaluation Processing>>

In the evaluation processing illustrated in FIG. 9, after initialization of R←O and Z←P[1]_{Z} (lines 1 and 2), the procedures of lines 4 to 17 are repeated while decreasing i from i=n−1 to i=0 by 1 (line 3), and R is output as R←(Rₓ, R_{Y}, R_{Z}·Z) (lines 19 and 20). In the procedures of lines 4 to 17, after setting R←2R (line 4), if kᵢ′≠0 and kᵢ′>0, then A←P[kᵢ′] is set (line 7), and if kᵢ′≠0 and kᵢ′≤0, then A←−P[−kᵢ′] is set (line 9). If kᵢ′≠0, then R (A_{X}, A_{Y}, 1) is set when R=O (line 12), and A←(R_{Z}²A_{X}, R_{Z}³A_{Y}, R_{Z}) and R←R+A are set when R≠0 (lines 14 and 15). On the other hand, if kᵢ′=0, nothing is performed.

In the evaluation processing illustrated in FIG. 9, in order to use the Co—Z method in the elliptic curve point addition in line 15, the Z coordinate is set to 1 at the time of initial value substitution of R in line 12. Accordingly, since the Z coordinate of R becomes a value obtained by multiplying the original value by 1/Z, coordinate conversion can be performed only by multiplication by R_{Z} in line 14. In addition, in line 19, by multiplying the Z coordinate by Z, correction corresponding to a change in the Z coordinate is performed, and a correct computation result is obtained.

<Comparison with Conventional Method>

Here, the scalar multiplication with precomputation using the Co—Z method described in Non-Patent Literature 1 is compared with the scalar multiplication with precomputation executed by the scalar multiplication device 10 according to the present embodiment.

Non-Patent Literature 1 describes a method in which pre-computation processing is performed using a Co—Z method, and then two types of evaluation processing are performed using a pre-computation table created by the pre-computation processing. The first method is a method of computing a result of scalar multiplication by using elliptic curve point addition and elliptic curve point doubling of the Jacobian coordinates in the evaluation processing using the pre-computation table as it is. The second method is a method in which the points constituting the pre-computation table are converted from Jacobian coordinates to affine coordinates, and then, in the evaluation processing, a result of the scalar multiplication is computed by the elliptic doubling of the Jacobian coordinates and the elliptic curve point addition in the mixed coordinates using the Jacobian coordinates and the affine coordinates as inputs.

In the first method described in Non-Patent Literature 1, the Co—Z method is used in the pre-computation processing, and thus the speed is high. On the other hand, the elliptic curve point addition in the evaluation processing is the elliptic curve point addition in the normal Jacobian coordinates not using the Co—Z method, and thus the speed is low. On the other hand, in the second method, similarly, the pre-computation processing is performed at a high speed, and elliptic curve point addition in the mixed coordinates at a high speed can be used also in the evaluation processing. However, it is necessary to convert the points constituting the pre-computation table to the affine coordinates. The conversion from the Jacobian coordinates into the affine coordinates requires multiplication and inverse calculation on F_{q} for one point, which is inefficient.

On the other hand, in the scalar multiplication with precomputation executed by the scalar multiplication device 10 according to the present embodiment, the Z coordinates of the points constituting the pre-computation table are converted into the same value using the properties of the Co—Z method, so that coordinate conversion can be performed by performing multiplication on F_{q} for one point several times. In addition, in the evaluation processing, the coordinate conversion and the elliptic curve point addition according to the Co—Z method can be computed at the same computational cost as the computation of the mixed coordinates.

Therefore, the scalar multiplication with precomputation executed by the scalar multiplication device 10 according to the present embodiment solves the disadvantage of the scalar multiplication with precomputation described in Non-Patent Literature 1, and the scalar multiplication can be computed at a higher speed.

### CONCLUSION

As described above, the scalar multiplication device 10 according to the present embodiment can efficiently compute the scalar multiplication with precomputation as compared with the conventional method. In addition, since the multi-scalar multiplication is an extension of the scalar multiplication, the scalar multiplication device 10 according to the present embodiment can also efficiently compute the multi-scalar multiplication in substantially the same way.

Note that elliptic curve cryptography is used, for example, when secure communication such as SSL/TLS is performed. In addition, the pairing-based cryptography is used, for example, when constructing advanced functional cryptography such as ID-based encryption or functional encryption. Therefore, the scalar multiplication device 10 according to the present embodiment can be applied to, for example, a device, an apparatus, or a system that performs communication by SSL/TLS or the like, or can be applied to a device, an apparatus, a system, or the like that performs key generation, encryption, decryption, or the like by ID-based encryption, functional encryption, or the like.

The present invention is not limited to the embodiments specifically disclosed as above, and various modifications and changes, combinations with known technique, and the like can be made without departing from the scope of the claims.

### REFERENCE SIGNS LIST

10 Scalar multiplication device
101 Input device
102 Display device
103 External I/F
103a Recording medium
104 Communication I/F
105 Processor
106 Memory device
107 Bus
201 Pre-computation processing unit
202 Scalar value conversion processing unit
203 Evaluation processing unit

1. A scalar multiplication system that computes a scalar multiplication for a point on an elliptic curve, and is applied to secure communication, the scalar multiplication system comprising:
a computer including a memory and a processor configured to execute
computing a pre-computation table T including d points eᵢP having the same Z coordinate in Jacobian coordinates using elliptic curve point addition or elliptic curve point doubling according to a Co—Z method for a point P on the elliptic curve and d integers eᵢ (i∈[1, d]);
converting a scalar value k into a scalar value k′ expressed as k′=k₀′2⁰+k₁′2¹+ . . . +kₙ₋₁′2ⁿ⁻¹(kᵢ′∈{0, ±e₁, . . . , ±e_{d}}); and
using the pre-computation table T and the scalar value k′ to compute a scalar multiplication k′P using the elliptic curve point addition according to the Co—Z method.

2. The scalar multiplication system according to claim 1, wherein
upon computing multi-scalar multiple k₀P₀+ . . . +kₘ₋₁Pₘ₋₁,
the processor computes a pre-computation table Ti for each point Pᵢ(i∈[0, m−1]),
the processor converts each scalar value kᵢ(i∈[0, m−1]) into kᵢ′=kᵢ₀′2⁰+kᵢ₁′2¹+ . . . +kₘ₋₁′2ⁿ⁻¹ (kᵢⱼ′∈{0, ±e₁, . . . , ±e_{d}}), and
the processor computes multi-scalar multiple k₀′P₀+ . . . +kₘ₋₁′Pₘ₋₁ using the pre-computation table Tᵢ(i∈[0, m−1]) and the scalar value kᵢ′ (i∈[0, m−1]) after conversion.

3. The scalar multiplication system according to claim 1, wherein
the processor computes eᵢP←eᵢ₋₁P+aP or eᵢP←2eᵢ₋₁P using elliptic curve point addition or elliptic curve point doubling, respectively, with a being a predetermined natural number, and then converts the Z coordinate of each eᵢP(i∈[1, d]) to compute the pre-computation table T.

4. A scalar multiplication device that computes a scalar multiplication for a point on an elliptic curve, and is applied to secure communication, the scalar multiplication device comprising:
a memory; and
a processor configured to execute
computing a pre-computation table T including d points eᵢP having the same Z coordinate in Jacobian coordinates using elliptic curve point addition or elliptic curve point doubling according to a Co—Z method for a point P on the elliptic curve and d integers eᵢ (i∈[1, d]);
converting a scalar value k into a scalar value k′ expressed as k′=k₀′2⁰+k₁′2¹+ . . . +kₙ₋₁′2ⁿ⁻¹(kᵢ′∈{0, ±e₁, . . . , ±e_{d}}); and
using the pre-computation table T and the scalar value k′ to compute a scalar multiplication k′P using the elliptic curve point addition according to the Co—Z method.

5. A scalar multiplication method executed by a computer that includes a memory and a processor to compute a scalar multiplication for a point on an elliptic curve, and to be applied to secure communication, the scalar multiplication method comprising:
computing a pre-computation table T including d points eᵢP having the same Z coordinate in Jacobian coordinates using elliptic curve point addition or elliptic curve point doubling according to a Co—Z method for a point P on the elliptic curve and d integers eᵢ(i∈[1, d]);
converting a scalar value k into a scalar value k′ expressed as k′=k₀′2⁰+k₁′2¹+ . . . +kₙ₋₁′2ⁿ⁻¹ (kᵢ′∈{0, ±e₁, . . . , ±e_{d}}); and
using the pre-computation table T and the scalar value k′ to compute a scalar multiplication k′P using the elliptic curve point addition according to the Co—Z method.

6. A non-transitory computer-readable recording medium having computer-readable instructions stored thereon, which, when executed, cause a computer to function as the scalar multiplication system according to claim 1.
